(19) United States
(12) Patent Application Publication
(10) Pub. No.: US 2016/0104501 A1
(43) Pub. Date: Apr. 14, 2016

(54) Method and Apparatus for Facilitating Conversation in a Noisy Environment

(71) Applicants: Christine Weingold, Studio City, CA (US); Peter Weingold, Studio City, CA (US)

(72) Inventors: Christine Weingold, Studio City, CA (US); Peter Weingold, Studio City, CA (US)

(21) Appl. No.: 14/512,068

(22) Filed: Oct. 10, 2014

(51) Int. Cl. G10L 21/0208; H04R 3/00

(52) U.S. Cl. CPC G10L 21/0208; H04R 3/002; G10L 2021/02087

(57) ABSTRACT

The present invention discloses a communication system to facilitate natural multiparty conversation in a noisy environment. The communication system may include a wireless headset. Each headset is connected to a wireless hub. In one embodiment, one of the headsets is integrated with the hub. Each participant in the conversation may wear the wireless headset. The speech from each non-hub headset is wirelessly communicated to the hub. The hub combines the speech from each participant into a conversation stream and transmits the conversation stream to all participants.

### BACKGROUND OF THE INVENTION

1. Field of the Invention

The present invention relates to technology for wireless communication and, in particular, to wireless technology for voice communication in a noisy environment.

2. Description of Related Art

People frequently carry on conversation in a noisy environment, such as diners conversing around a table at a noisy restaurant, first responders communicating in an emergency situation, friends talking in a public place, etc. Because people may have trouble hearing each other, one may have to shout to be heard. Even with shouting, however, it may be difficult for all of the interested party to hear or to participate in a single conversation.

Communication systems have been developed to facilitate conversation in noisy conditions. For example, helmet mounted systems allow motorcycle riders, constructions workers, and first responders to converse with one another. However, none of these systems provides the combination of features required for carrying on natural conversation in a noisy environment. These requirements may include low-latency (<45 milliseconds), wide audio bandwidth (50-7500 Hz), high dynamic range, full-duplex communication, noise and echo reduction, speech enhancement, non-directional link, non-mouth blocking, long battery life, and multi-party operation.

Latency is the time interval between when a participant in a conversation utters a sound and when that sound is heard by all participants. Latency is not a significant issue for helmet mounted systems since the participants arc not looking at each other's lips while communicating. However, it is a significant issue for enhanced conversation systems where participants may be sitting around a dinner table. In fact, latency exceeding 45 milliseconds will be perceived as loss of sync between speech and mouth movement.

In addition, existing systems provide, at best, telephone equivalent audio bandwidths of 300-3400 Hz and dynamic ranges of 40 to 50 dB. This is adequate for remote communication, as evidenced by telephone usage, but does not provide the sense and feel of natural face-to-face conversation. It is well known that 100% intelligibility requires 5,000 Hz of audio bandwidth. The human voice has frequencies from 80 Hz to 10,000 Hz. The 300-3400 Hz bandwidth offered by existing systems loses two octaves on bass and two on treble. This loss of bandwidth produces a voice that is decidedly metallic. A wider, 50-7500 Hz, bandwidth is required for natural sounding conversation. Also, the normal human ear operates with 90 dB of dynamic range. Natural sounding conversation requires a 60 to 70 dB dynamic range, about 20 dB more than that of the existing system.

Furthermore, some existing systems are simplex (similar to push-to-talk radios); some do not provide noise and echo reduction or speech enhancement processing; others require that one participant face another participant, or point a microphone at another participant, to hear what that participant is saying. These shortcomings prevent natural multiparty conversations. For natural sounding conversation, full-duplex communication, noise and echo reduction, and speech enhancement are desired. Helmet mounted systems also inherently interfere with eating. Non-mouth blocking is a requirement for enhanced conversation systems where the participants may be sitting around a dinner table.

Therefore, it is desirable to provide an improved communication system to facilitate natural multiparty conversation in a noisy environment.

### SUMMARY OF THE INVENTION

An objective of the present invention is to provide a wireless headset. Each headset is connected to a wireless hub. In one embodiment, one of the headsets is integrated with the hub. Each participant in the conversation may wear the wireless headset. The hub combines the speech from each participant and transmits the speech to all participants.

Disclosed is a method for enhancing conversation between participants. In one embodiment of the present invention, the method includes capturing the speech of one of the participants by a microphone of a wireless headset. The method also includes wirelessly transmitting the captured speech to a hub. The method further includes wirelessly receiving a conversation stream from the hub. The conversation stream is a combination of speeches from all the participants. The method further includes radiating the conversation stream from a headphone of the wireless headset to the one participant.

In one embodiment of the present invention, the method includes wirelessly receiving speech samples of one or more remote participants by a hub. The method also includes receiving speech samples of a local participant from a headset, if any, that is integrated with the hub. The method further includes combining the speech samples from all the participants into a conversation stream. The method further includes wirelessly transmitting the conversation stream the hub to the one or more remote participants.

Disclosed is an apparatus used in wireless communication to enhance conversation between participants. In one embodiment of the present invention, the apparatus includes a microphone used to receive the speech of a user. The apparatus also includes a sampling circuit used to convert the speech into speech samples. The apparatus further includes a processor used to encode and modulate the speech samples. The processor is further used to demodulate and decode a conversation stream received from a hub. The conversation stream is a combination of speech samples from multiple users. The apparatus further includes a transceiver used to transmit the speech samples to the hub. The transceiver is also used to receive the conversation stream from the hub in full duplex. The apparatus further includes a headphone used to radiate the conversation stream to the user.

In one embodiment of the present invention, the apparatus includes a transceiver used to receive speech samples from one or more headsets. The transceiver is also used to transmit a conversation stream in full duplex to the one or more headsets. The apparatus also includes a processor used to demodulate and decode the speech samples from the one or more headsets. The processor is also used to combine the demodulated and decoded speech samples from all the headsets in combined samples. The processor is further used to encode and to modulate the combined samples into the conversation stream.

Advantageously, participants wearing a headset may carry on natural multiparty conversation in a noisy environment.

### BRIEF DESCRIPTION OF THE DRAWINGS

The accompanying drawings are provided together with the following description of the embodiments for a better comprehension of the present invention The drawings and the embodiments are illustrative of the present invention, and are not intended to limit the scope of the present invention. It is understood that a person of ordinary skill in the art may modify the drawings to generate drawings of other embodiments that would still fall within the scope of the present invention.

FIG. 1 illustrates participants using the headsets of the enhanced conversation system to converse with one another through a stand-alone hub according to one or more embodiments of the present invention;

FIG. 2 illustrates participants using the headsets of the enhanced conversation system to converse with one another through a hub that is integrated with one of the headsets according to one or more embodiments of the present invention;

FIG. 3 shows a top level block diagram of an enhanced conversation system with a stand-alone hub according to one or more embodiments of the present invention;

FIG. 4 shows a top level block diagram of an enhanced conversation system with a hub that is integrated into a headset according to one or more embodiments of the present invention;

FIG. 5 shows the audio flow in an enhanced conversation system according to one or more embodiments of the present invention;

FIG. 6 shows a top level block diagram of the wireless headset of the enhanced conversation system of FIG. 1 according to one or more embodiments of the present invention;

FIG. 7 shows a block diagram of the data processing of the FPGA of the non-hub headset of FIG. 6 according to one or more embodiments of the present invention;

FIG. 8 shows the timing of the wireless link of the enhanced conversation system according to one or more embodiments of the present invention;

FIG. 9 shows a top level block diagram of the standalone hub of the enhanced conversation system according to one or more embodiments of the present invention;

FIG. 10 shows a block diagram of the data processing of the FPGA of the hub of FIG. 9 according to one or more embodiments of the present invention; and

FIG. 11 shows a block diagram of the data processing of the FPGA of the hub headset of FIG. 6 according to one or more embodiments of the present invention.

### DETAILED DESCRIPTION

The following paragraphs describe several embodiments of the present invention in conjunction with the accompanying drawings. Like reference numerals are used to identify like elements in one or more of the drawings. It should be understood that the embodiments are used only to illustrate and describe the present invention, and are not to be interpreted as limiting the scope of the present invention.

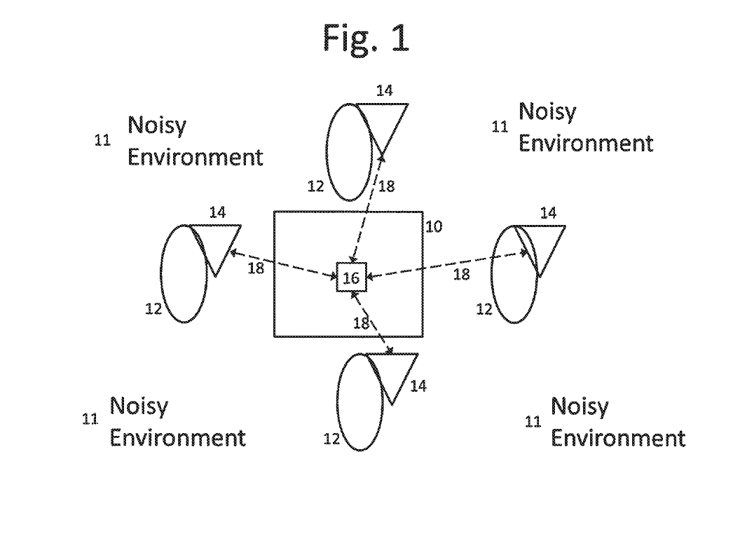

FIG. 1 illustrates participants using the headsets of the enhanced conversation system to converse with one another through a stand-alone hub according to one or more embodiments of the present invention. Participants 12 are seated around a table 10 conversing in a noisy environment 11. Each participant 12 wears a headset 14 incorporating an earpiece for radiating sound into the ear of that participant 12 and a microphone for capturing the speech of that participant 12. In one or more embodiments of the present invention, the microphone has noise-cancellation, noise-reduction, and/or echo-cancellation capability. Headset 14 processes the captured speech into audio signals. A wireless transceiver in headset 14 uses a wireless links 18 to transmit the audio signals of the speech of participant 12 to a hub 16. Wireless link 18 may be shared by multiple headsets 14 using one of several multiple access schemes to transmit audio signals from participants 12 in a multi-party conversation.

A wireless transceiver in the hub 16 receives the audio streams from the multiple headsets 14. Hub 16 uses digital signal processing to process and combine the multiple audio streams into a single conversation stream. Hub 16 may have noise-cancellation, noise-reduction, echo-cancellation, and/or speech enhancement capability. The wireless transceiver in hub 16 uses wireless link 18 to transmit the conversation stream back to each headset 14. Hub 16 shares wireless link 18 with headsets 14 in full duplex operation. The wireless transceiver in headset 14 receives the conversation stream from hub 16. Headset 14 processes and radiates the conversation steam to each participant 12 through the earpiece.

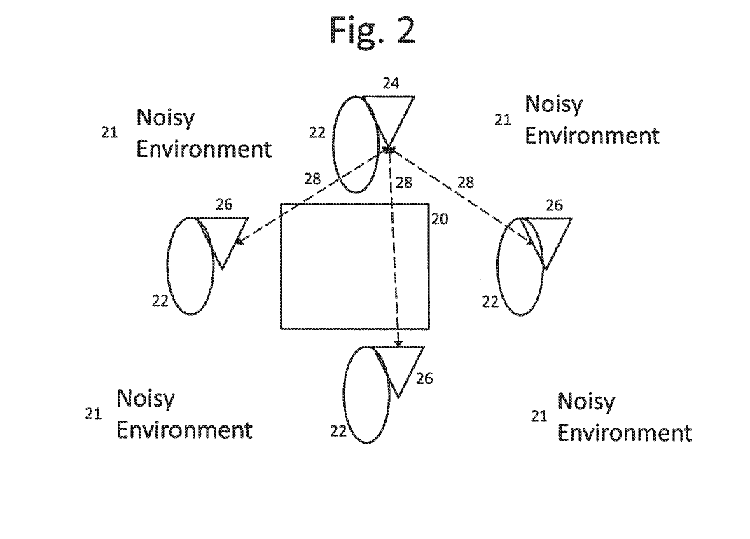

FIG. 2 illustrates participants using the headsets of the enhanced conversation system to converse with one another through a hub that is integrated with one of the headsets according to one or more embodiments of the present invention. Participants 22 are seated around a table 20 conversing in a noisy environment 21. One of the participants 22 wears a hub headset 24. Each of the other participants 22 wears a non-hub headset 26. Hub headset 24 and non-hub headset 26 each provides an earpiece for radiating sound into the ear of that participant 22 and a microphone for capturing the speech of that participant 22. In one or more embodiments of the present invention, the microphone has noise-cancellation, noise-reduction, and/or echo-cancellation capability when processing the speech into audio signals. A wireless transceiver in each non-hub headset 26 sends the audio signals captured by its microphone to hub headset 24 using a wireless link 28. Wireless link 28 may be shared by multiple non-hub headsets 26 using one of several multiple access schemes to transmit audio signals from participants 22 in a multi-party conversation.

A wireless transceiver in the hub headset 24 receives the audio streams from multiple non-hub headsets 26. Hub headset 24 incorporates digital signal processing to process and combine the multiple audio streams, including the one from its own microphone, into a conversation stream. Hub headset 24 may have noise-cancellation, noise-reduction, echo-cancellation, and/or speech enhancement capability. The wireless transceiver in hub headset 24 uses wireless link 28 to transmit the conversation stream back to each non-hub headset 26. Hub headset 24 shares wireless link 28 with non-hub headsets 26 in full duplex communication. The wireless transceiver in non-hub headset 26 receives the conversation stream from hub headset 24. Non-hub headset 26 processes and radiates the conversation steam to each participant 22 wearing non-hub headset 26 through the earpiece. Hub headset 24 also radiates the conversation stream to participant 22 wearing hub headset 24.

One or more embodiments of the present invention use Bluetooth wireless links to connect the headsets in a piconet. A piconet consists of two or more devices occupying the same physical channel (synchronized to a common clock and hopping sequence). A Bluetooth piconet may have a master device. The common (piconet) clock is identical to the clock of the master device in the Bluetooth piconet and the hopping sequence is derived from the clock and the Bluetooth device address of the master device. All other synchronized devices are slaves in the Bluetooth piconet.

Bluetooth enabled devices use an inquiry procedure to discover nearby devices, or to be discovered by devices in their locality. The inquiry procedure is asymmetrical. A Bluetooth enabled device trying to find other nearby devices is known as an inquiring device. The inquiring device actively sends inquiry requests to discover nearby devices. Bluetooth enabled devices available to be found by the inquiring device are “discoverable” they listen for inquiry requests and send responses back to the inquiring device.

Once an inquiring device discovers other nearby Bluetooth enabled devices, connections may be formed between the devices. The procedure for forming connections is asymmetrical and requires that one Bluetooth enabled device carry out the page (connection) procedure while the other Bluetooth enabled device is connectable (page scanning). The procedure is targeted, so the page procedure from the paging (connecting) device is only responded to by one specified Bluetooth enabled device, called the connectable device. The connectable device uses a special physical channel to listen for connection request packets from the paging device. This physical channel has attributes specific to the connectable device, hence only a paging device with knowledge of the connectable device is able to communicate on this channel.

In one or more embodiments of the present invention, the Bluetooth wireless links may be replaced with other low-latency full-duplex links such as Wi-Fi wireless links, other standardized wireless links, non-standard wireless links, or free-space optical links.

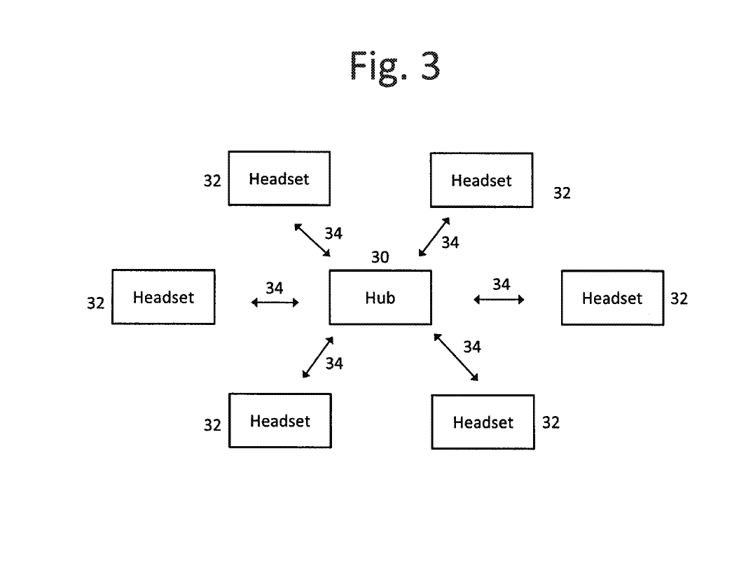

FIG. 3 shows a top level block diagram of an enhanced conversation system with a stand-alone hub according to one or more embodiments of the present invention. Devices of the enhanced conversation system are linked via a Bluetooth piconet. A hub 30 is the master of the Bluetooth piconet. Headsets 32 are slaves of that piconet. Hub 30 and headsets 32 may discover each other and form connections between them using the inquiry procedure and the page procedure as described. Each headset 32 is worn by one of the participants in the conversation, and provides an earpiece for radiating sound into the ear of that participant and a microphone for capturing the speech of that participant. Headset 32 processes the speech captured by the microphone into audio signals. A Bluetooth transceiver in headset 32 sends the audio signals to hub 30 using a Bluetooth link 34.

A Bluetooth transceiver in hub 30 receives the audio streams from the multiple headsets 32. Hub 30 incorporates digital signal processing to process and combine the multiple audio streams into a conversation stream. The Bluetooth transceiver in hub 30 transmits the conversation stream to the multiple headsets 32 using Bluetooth link 34. The Bluetooth transceiver in headset 32 receives the conversation stream from hub 30. Headset 32 processes the conversation stream and radiates the processed conversation stream through its earpiece to the participant. Physical channels in Bluetooth link 34 may be shared by multiple headsets 32 and hub 30 using one of several multiple-access schemes, such as time division multiple access (TDMA), frequency division multiple access (FDMA), code division multiple access (CDMA), or others. In one or more embodiments of the present invention, hub 30 may be replaced by Bluetooth enabled devices including smartphones, tablets, laptops, or other portable or mobile communication/computing devices. In one or more embodiments of the present invention, Bluetooth link 34 may be replaced by other low-latency full-duplex links such as Wi-Fi wireless links, other standardized wireless links, non-standard wireless links, or free-space optical links.

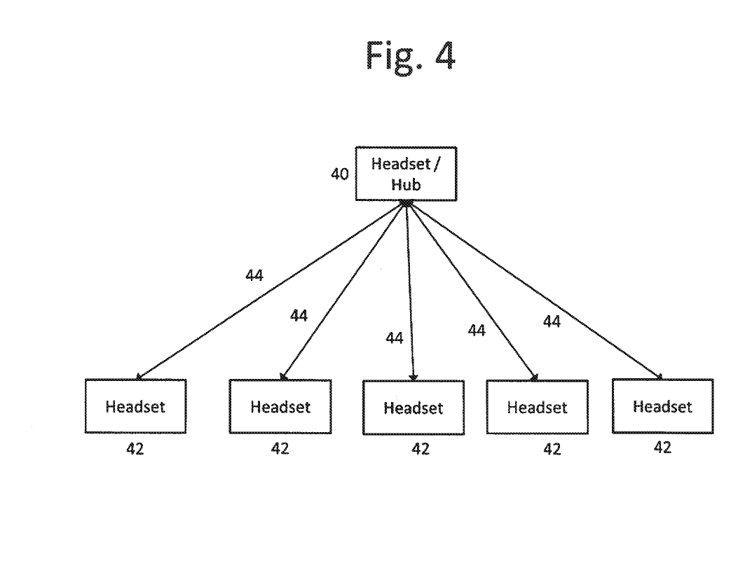

FIG. 4 shows a top level block diagram of an enhanced conversation system with a hub that is integrated into a headset according to one or more embodiments of the present invention. Devices of the enhanced conversation system are linked via a Bluetooth piconet. One of the headsets is a hub headset 40 and is also the master of the Bluetooth piconet. The remaining headsets are non-hub headsets 42 and are slaves of the Bluetooth piconet. Hub headset 40 and each of the non-hub headsets 42 are worn by the participants in the conversation, with each headset providing an earpiece for radiating sound into the ear of that participant and a microphone for capturing the speech of that participant. Hub headset 40 and non-hub headset 42 each processes the speech captured by its microphone into audio signals. A Bluetooth transceiver in each of the non-hub headsets 42 sends the audio signals to hub headset 40 using a Bluetooth link 44.

A Bluetooth transceiver in hub headset 40 receives the audio streams from the multiple non-hub headsets 42. Hub headset 40 incorporates digital signal processing to process and combine the multiple audio streams, including the one from its own microphone, into a conversation stream. The Bluetooth transceiver in hub headset 40 transmits the conversation stream to the multiple non-hub headsets 42 using Bluetooth link 44. The Bluetooth transceiver in non-hub headset 42 receives the conversation stream from hub headset 40. Non-hub headset 42 processes the conversation stream and radiates the processed conversation stream through its earpiece to the participant. The conversation stream from hub headset 40 is also radiated by the earpiece of hub headset 40. Physical channels in Bluetooth link 44 may be shared by multiple non-hub headsets 42 and hub headset 40 using one of several multiple access schemes. In one or more embodiments of the present invention, Bluetooth link 34 may be replaced by other low-latency full-duplex links.

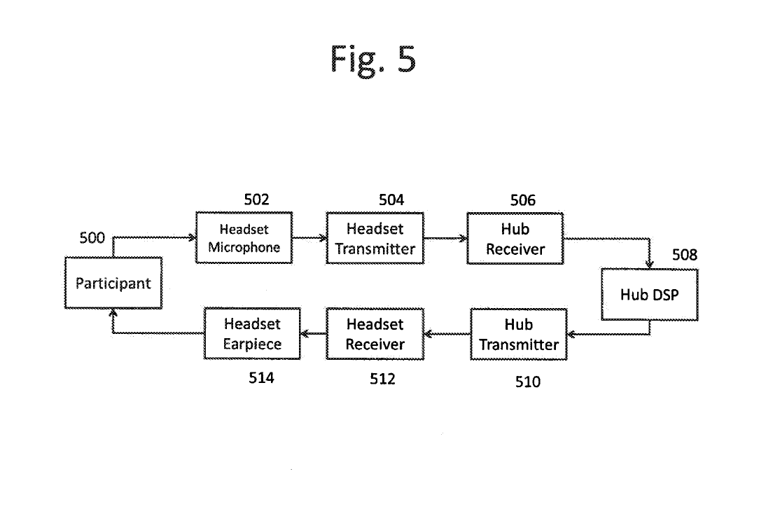

FIG. 5 shows the audio flow in an enhanced conversation system according to one or more embodiments of the present invention. The speech from each participant 500 is captured by a headset microphone 502. Headset microphone 502 converts the free-space propagated audible speech into an electrical signal. The electrical signal is sampled and digitized. The digitized samples are encoded and sent to a headset transmitter 504. Headset transmitter 504 converts the encoded samples into a wireless signal and transmits it through a wireless link. The transmitted wireless signal is received by a hub receiver 506. Hub receiver 506 converts and decodes the free space propagated wireless signal into samples of the audible speech from participant 500. A hub DSP 508 processes and combines the speech samples recovered from each of the participants 500. The samples from the combined conversation stream are encoded and converted into a wireless signal by a hub transmitter 510. Hub transmitter 510 transmits the wireless signal representing the combined conversation stream through the wireless link back to a handset receiver 512. Handset receiver 512 converts and decodes the free-space propagated wireless signal into samples of the combined conversation stream. These samples are converted into audio signals by a headset earpiece 514. Headset earpiece 514 provides the audio signals representing the combined conversation stream to participant 500.

Hub DSP 508 may process the audio streams received from each headset transmitter 504 to reduce noise and reduce echoes. After echoes and noise have been reduced in each of the individual audio streams, they are combined in a single conversation stream. Hub DSP 508 may further process the conversation stream to enhance speech. One of ordinary skill of the art will recognize that the processing steps may be performed in different orders and that not all of the steps are necessary. Also, one skilled in the art will recognize that the processing may be partitioned between the hub and the wireless headsets in various ways.

One or more embodiments of the present invention may incorporate echo cancelling in hub DSP 508. Echo cancellers operate by synthesizing an estimate of the echo from the participant's speech stream, and subtracting that synthesis from the conversation stream. This technique uses adaptive signal processing to generate a signal accurate enough to effectively cancel the echo, where the echo can differ from the original due to various kinds of degradation along the path from a participant's microphone to the conversation stream corning out of that participant's headphones.

One or more embodiments of the present invention may incorporate speech enhancement in hub DSP 508. Speech enhancement consists of temporal and spectral methods to improve the signal to noise ratio of a speech signal.

One or more embodiments of the present invention may incorporate a noise cancelling microphone in the wireless headsets. These microphones may have two ports through which sound enters; one port oriented toward the participant's mouth and one orientated in another direction. The microphone's diaphragm is placed between the two ports; sound arriving from an ambient sound field reaches both ports more or less equally. Participant's speech will make more of a pressure gradient between the front and back of the diaphragm, causing it to move more. The microphone's proximity effect is adjusted so that flat frequency response is achieved for the participant's speech. Sounds arriving from other angles are subject to steep midrange and bass roll-off.

In one or more embodiments of the present invention, noise cancelling microphones using two or more microphones and active or passive circuitry may be used to reduce the noise. The primary microphone is closer to the participant's mouth. A second microphone receives ambient noise. In a noisy environment, both microphones receive noise at a similar level, but the primary microphone receives the participant's speech more strongly. Thus if one signal is subtracted from the other (in the simplest sense, by connecting the microphones out of phase), much of the noise may be canceled while the desired sound is retained.

The internal electronic circuitry of a noise-canceling microphone may attempt to subtract the noise signal from the primary microphone. The circuitry may employ passive or active noise canceling techniques to filter out the noise, producing an output signal that has a lower noise floor and a higher signal-to-noise ratio.

One or more embodiments of the present invention may incorporate noise cancelling headphones in the wireless headset. The materials of the headphones may provide some passive noise blocking. Active noise-cancellation techniques may be used to erase lower-frequency sound waves. A microphone placed inside the ear cup may “listen” to external sounds that remain after passive blocking. Electronic circuits sense the input from the microphone and generate a wave that is 180 degrees out of phase with the waves associated with the noise. This “anti-sound” is input to the headphones' speakers along with the conversation audio; the anti-sound reduces the noise by destructive interference, but does not affect the desired sound waves in the conversation audio.

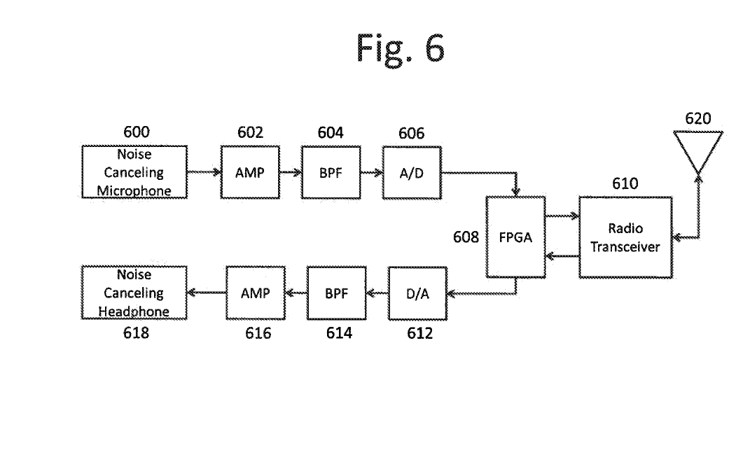

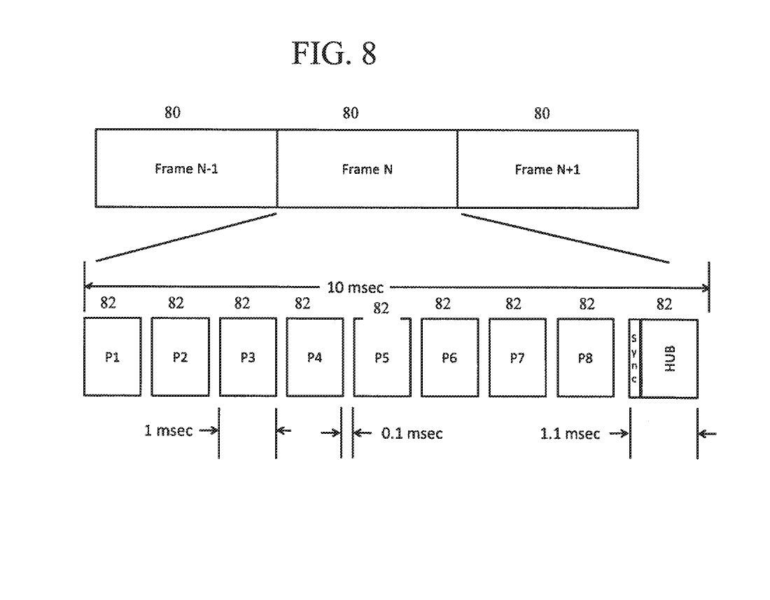

FIG. 6 shows atop level block diagram of the wireless headset of the enhanced conversation system of FIG. 1 according to one or more embodiments of the present invention. The participant's speech is received by a noise canceling microphone 600. Output from noise canceling microphone is amplified by an amplifier 602 to set the noise floor. A bandpass filter (BPF) 604 with a pass band of 50 Hz to 7500 Hz filters the output from amplifier 602 to attenuate out-of-band noise. The bandpass filtered speech signal is digitized by a 12-bit AID 606 at 16 kHz. The 12-bit quantization provides approximately 76 dB dynamic range and the 16 kHz sampling rate mitigates aliasing of the band-limited speech signal. The quantized speech samples are input to afield programmable gate array (FPGA) 608 where they are partitioned into 10 millisecond frames, each frame comprising 160 samples, or 1920 bits. The 1920 bits are rate-1/2 coded for error protection into a 3820 bit packet. The packets are then QPSK modulated at 1.92 Mbaud to form a 1 millisecond baseband burst. The baseband burst timing is then adjusted to a designated slot 82 in a 10 millisecond frame 80 of FIG. 8, and input to an RF transceiver 610 which up-converts the baseband burst to the RF transmission frequency and outputs it to an antenna 620. Antenna 620 transmits the burst RF transmission through the wireless link to hub 16. In one or more embodiments of the present invention, FPGA 608 may be implemented by other programmable logic arrays (PLAs), an application specific integrated circuit (ASIC), a digital signal processor (DSP), or software/firmware running on a processor.

Antenna 620 also receives the burst transmissions from hub 16 and inputs them to RF transceiver 610. RF transceiver 610 down-converts the received bursts to baseband signals and outputs them to FPGA 608. FPGA 608 demodulates the baseband signal, decodes it, selects the 1 millisecond burst 84 from hub 16 (shown in FIG. 8), and outputs the 12-bit samples at 16 kHz to a D/A 612. D/A 612 converts the digitized samples to an analog voltage and outputs it to a BPF 614 which has a 50 Hz to 7500 Hz bandwidth and is used to reconstruct the conversation stream from hub 16. The reconstructed conversation stream is input to an amplifier 616. The amplified conversation stream is input to a noise cancelling headphone 618 which radiates it into the ear of participant 12.

FIG. 6 may also represent a top level block diagram of the hub headset 24 of the enhanced conversation system of FIG. 2 according to one or more embodiments of the present invention. Speech from a hub headset-wearing participant 22 is received by noise canceling microphone 600, amplified by amplifier 602, filtered by bandpass filter (BFP) 604, and digitized by 12-bit A/D 606 at 16 KHz. The quantized speech samples are input to FPGA 608 and partitioned into 10 millisecond frames of 160 samples, or 1920 bits.

Antenna 620 receives the burst transmissions from non-hub headsets 26 during their assigned slots as shown in the frame structure of FIG. 8 and inputs them to RF transceiver 610. RF transceiver 610 down-converts the received bursts to baseband signals and outputs them to FPGA 608. FPGA 608 demodulates the baseband signals for each non-hub headset 26, decodes it, and may perform echo and/or noise canceling to generate a 1920 bit packet representing 10 milliseconds of speech samples for each non-hub headset 26. The 1920 bit packets for all of non-hub headsets 26 and the 1920 bit packet for hub headset 24 are combined to generate the conversation stream. The conversation stream may be processed to enhance speech. FPGA 608 outputs the conversation stream as 12-bit samples at 16 KHz to D/A 612. D/A 612 converts the digitized samples to an analog voltage and outputs it to BPF 614 for baseband filtering. The baseband filtered conversation stream is amplified by amplifier 616 and output to noise canceling headphone 618 which radiates it into the ear of participant 22 wearing hub headset 24.

The conversation stream is also rate-1/2 coded for error protection into a 3820 bit packet. The packet is then QPSK modulated at 1.92 Mbaud to form a 1 millisecond baseband burst. The baseband burst is allocated to the designated slot 84 for the hub in the 10 millisecond frame 80 of FIG. 8, and input to RF transceiver 610 which up-converts the baseband burst to the RF transmission frequency and outputs it to antenna 620. Antenna 620 transmits the burst RF transmission of the conversation stream through the wireless link to non-hub headsets 26.

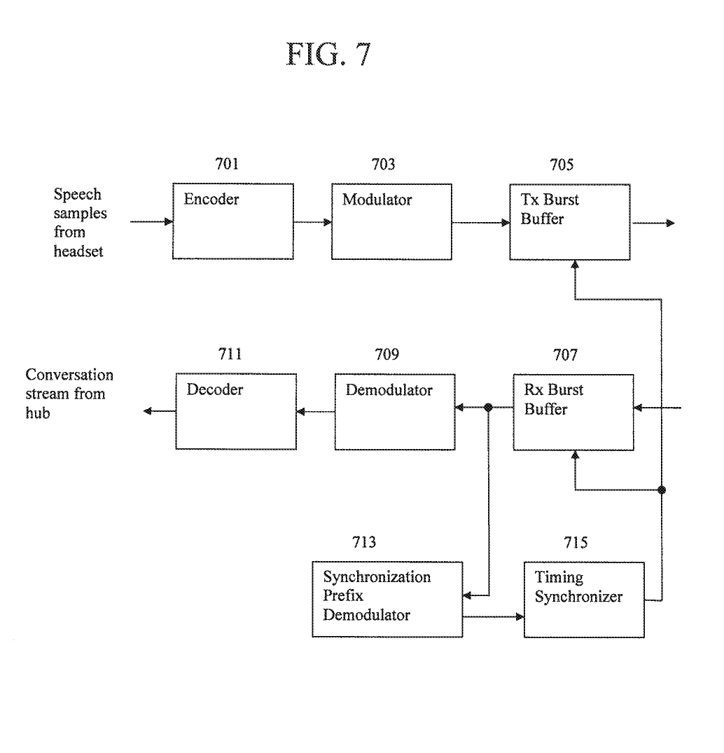

FIG. 7 shows a block diagram of the data processing of the FPGA 608 of the non-hub headset of FIG. 6 according to one or more embodiments of the present invention. The quantized speech from the non-hub headset represented as 12-bit data samples at 16 KHz are encoded by an encoder 701 for error protection. For example, encoder 701 may be a rate-1/2 encoder that encodes each 12-bit data sample into 24 bits. The encoded data are modulated by a modulator 703. For example, modulator 703 may be a QPSK modulator that modulates each 24-bit encoded data sample into 12 QPSK symbols. The modulated symbols are partitioned into data frames, buffered, and burst out at a faster rate to enable time division multiplexing of the modulated speech samples from multiple headsets over the wireless link. For example, a Tx burst buffer 705 may partition the QPSK-modulated data into a 10 millisecond packet of 1920 symbols. The 1920 symbols are buffered and burst out at 1.92 Mbaud to form a 1 millisecond baseband burst. The 1 millisecond baseband burst is allocated to a designated slot 82 for the headset in the 10 millisecond frame 80 of FIG. 8, up-converted to RF transmission frequency, and transmitted over the wireless link to hub 16.

Burst transmission of the conversation stream received from hub 16 during designated hub slot 84 of the 10 millisecond frame 80 is down-converted to baseband signals and buffered by an Rx burst buffer 707. The 1 millisecond burst of conversation stream representing 1920 QPSK symbols of data is read out of Rx burst buffer 707 over the 10 millisecond duration of the frame. The 1920 QPSK symbols are demodulated by a demodulator 702 to 3840 bits and decoded by a rate-1/2 decoder 711 to recover the 1920-bit packet of the conversation stream. The conversation stream is output as 12-bit samples at 16 KHz over the 10 millisecond frame and converted to analog voltage waveforms for radiating to the earphone of the headset.

To synchronize the non-hub headset with the frame timing, a synchronization prefix demodulator 713 demodulates the synchronization prefix symbols received at the beginning of designated hub slot 84 of the 10 millisecond frame. When synchronization prefix demodulator 713 detects the synchronization prefix, a timing synchronizer 715 synchronizes a frame timer to the beginning of designated hub slot 84. The frame timer keeps track of the frame timing and generates timing signals to Tx burst buffer 705 to burst out the 1 millisecond packet from the headset at the allocated slot 82. The frame timer also generates timing signals to Rx burst buffer 707 to receive the 1 millisecond packet of conversation stream from hub 16 during designated hub slot 84.

FIG. 8 shows the timing of the wireless link of the enhanced conversation system according to one or more embodiments of the present invention. A TDMA architecture is used with frames 80 of 10 millisecond duration. Each frame is divided into nine burst time slots. The 1.1 millisecond time slot HUB 84 is used by hub 16 to transmit the conversation stream and timing synchronization. The remaining eight 1 millisecond burst time slots 82 are used by each of the up to eight participants 12 in the conversation. Each of the time slots are separated by a 0.1 milliseconds guard time. The participant speech 12 captured during a 10 millisecond frame 80 is transmitted to the hub 16 during the next 10 millisecond frame 80, and processed into the conversation stream by the hub 16 during the first part of the next 10 millisecond frame. The conversation stream is transmitted to the participant 12 headsets during HUB 84 burst of the third frame, and heard by the participants during the next 10 millisecond frame. This combination provides a 30 millisecond latency.

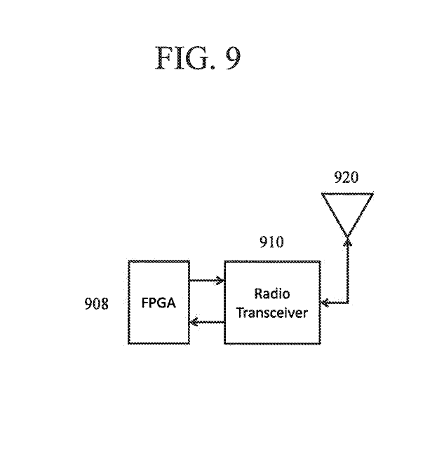

FIG. 9 shows a top level block diagram of the stand-alone hub 16 of the enhanced conversation system according to one or more embodiments of the present invention. An antenna 920 receives the burst transmissions from headsets 14 of participants 12 and inputs them to an RF transceiver 910. RF transceiver 910 down-converts the received bursts to baseband signals and outputs them to an FPGA 908. FPGA 908 demodulates the baseband signal, decodes it, and selects the up to eight 1 millisecond bursts 82 from each participant 12.

FPGA 908 processes the received audio streams to reduce noise and reduce echoes. After echoes and noise have been reduced in each of the individual audio streams, they are combined in a single conversation stream. The conversation stream may be processed to enhance speech. The conversation stream bits are rate-1/2 coded for error protection into a 3820 bit packet. The packets are then QPSK modulated at 1.92 Mbaud and prefixed with a 191 bit BPSK modulated PN sequence for timing synchronization to form a 1.1 millisecond baseband burst. The baseband burst timing is then adjusted to HUB slot 84 in the 10 millisecond frame 80 and input to RF transceiver 910 which up-converts the baseband burst to the RF transmission frequency and outputs it to antenna 920.

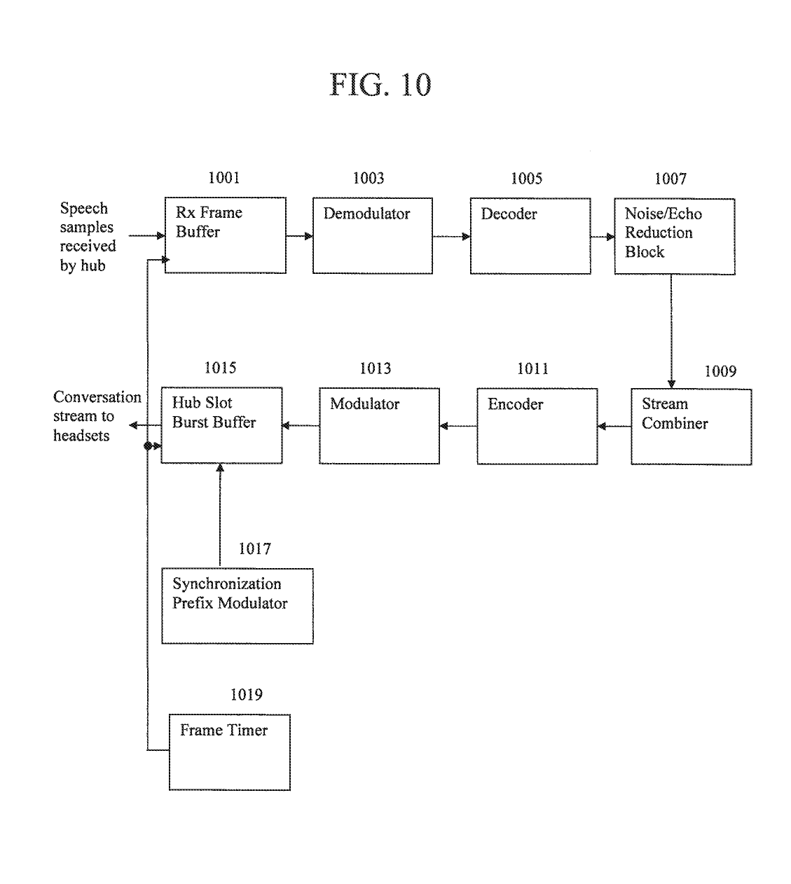

FIG. 10 shows a block diagram of the data processing of FPGA 908 of the stand-alone hub of FIG. 9 according to one or more embodiments of the present invention. The quantized speech from headsets 14 are received during slots 82 of the frame by an Rx frame buffer 1001. The 1 millisecond burst of quantized samples from each handset 14 representing 1920 QPSK symbols are demodulated by a demodulator 1003 to 3840 bits and decoded by a rate-1/2 decoder 1005 to recover the 1920-bit packet. The 1920-bit packet is processed by a noise/echo reduction block 1007 for noise or echo reduction. The 1920-bit packets from multiple headsets are combined by a stream combiner 1009 into a conversation stream. The conversation stream may be processed to enhance speech. The 1920-bit packet of the conversation stream is rate-1/2 coded by an encoder 1011 for error protection into a 3820 bit packet. The packet is then QPSK modulated by a modulator 1013 into 1910 symbols. The modulated symbols are received by a hub slot burst buffer 1015 and burst out at 1.92 Mbaud.

The conversation stream packet is prefixed with a 191 bit BPSK modulated PN sequence from a synchronization prefix modulator 1017 for timing synchronization to form a 1.1 millisecond baseband burst. The baseband burst is then allocated to HUB slot 84 in the 10 millisecond frame 80, up-converted to RF transmission frequency, and transmitted over the wireless link to headsets 14. A frame timer 1019 keeps track of the frame timing and generates timing signals to Rx frame buffer 1001 to receive the 1 millisecond packets of speech samples from headsets 14 during designated slots 82. Frame timer 1019 also generates timing signals to hub slot burst buffer 1013 to transmit the 1 millisecond packet of conversation stream from hub 16 during designated hub slot 84 of the frame.

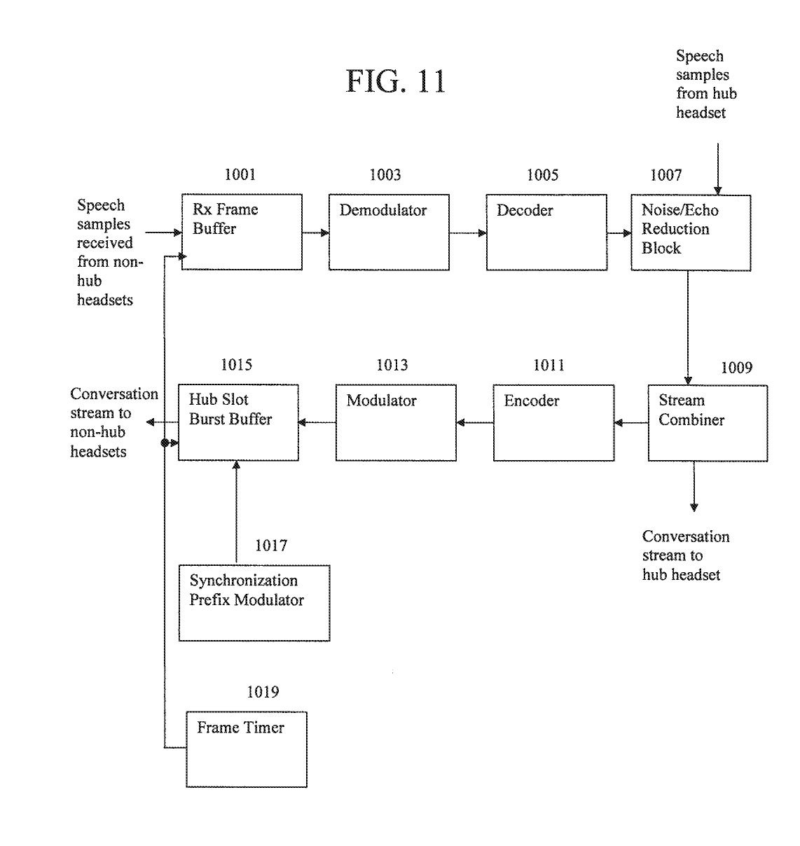

FIG. 11 shows a block diagram of the data processing of FPGA 608 of the hub headset of FIG. 6 according to one or more embodiments of the present invention. The data processing in FIG. 11 is similar to the data processing of FPGA 908 of the stand-alone hub described in FIG. 10 and will not be described. One difference in data processing from that performed by the stand-alone hub is that the 1920-bit packet of quantized speech samples from the hub headset is combined with the 1920-bit packets from multiple headsets by stream combiner 1009 into the conversation stream. The conversation stream is also converted to analog voltage, filtered, amplified, and radiated to the earphone of the hub headset.

The descriptions set forth above are provided to illustrate one or more embodiments of the present invention and are not intended to limit the scope of the present invention. Although the invention is described in details with reference to the embodiments, a person skilled in the art may obtain other embodiments of the invention through modification of the disclosed embodiment or replacement of equivalent parts. It is understood that any modification, replacement of equivalent parts and improvement are within the scope of the present invention and do not depart from the spirit and principle of the invention as hereinafter claimed.

1. A method for enhancing a conversation between participants, comprising:
capturing speech of one of the participants by a microphone of a wireless headset to generate speech samples;
wirelessly transmitting by the wireless headset the speech samples to a hub;
wirelessly receiving by the wireless headset in a full-duplex communication a conversation stream from the hub, wherein the conversation stream includes the speech samples received by the hub from any and all of the participants in the conversation to stream the speech samples from any and all of the participants to the one participant; and
radiating the conversation stream from a headphone of the wireless headset to the one participant to stream the speech from any and all of the participants in the conversation to the one participant.

2. The method of claim 1, further comprising canceling noise received by the microphone.

3. The method of claim 1, further comprising canceling noise by the headphone of the wireless headset.

4. The method of claim 1, wherein said wirelessly transmitting and wirelessly receiving comprises communicating using a Bluetooth piconet.

5. The method of claim 1, wherein said wirelessly transmitting comprises buffering the speech samples and bursting the speech samples over a time slot of a frame assigned to the wireless headset at a rate higher than a rate at which the speech samples are generated.

6. The method of claim 5, further comprising the wireless headset synchronizing to a synchronization signal received from the hub to determine the assigned time slot.

7. The method of claim 1, wherein said wirelessly receiving comprises receiving the conversation stream in a burst over a time slot of a frame assigned to the hub and buffering the burst of conversation stream for radiating the conversation stream from the wireless headset over the frame at a slower rate than a rate at which the conversation stream is received.

8. A method for enhancing a conversation between participants, comprising:
wirelessly receiving by a hub speech samples of any and all of the participants in the conversation;
receiving by the hub speech samples of local participant from a headset, if any, that is integrated with the hub;
combining by the hub all of the speech samples received into a conversation stream that includes the speech samples from any and all of the participants in the conversation; and
wirelessly transmitting the conversation stream from the hub back to any and all of the participants from whom speech samples are received to stream the speech samples in a full-duplex communication from any and all of the participants to any and all of the participants in the conversation.

9. The method of claim 8, further comprising processing the speech samples to cancel echo.

10. The method of claim 8, further comprising processing the speech samples to cancel noise.

11. The method of claim 8, wherein an audio frequency of the conversation stream is from 125 to 5000 Hz.

12. The method of claim 8, wherein said wirelessly transmitting and wirelessly receiving comprises communicating using a Bluetooth piconet.

13. The method of claim 8, wherein said wirelessly transmitting the conversation stream comprises transmitting the conversation stream in a burst over a time slot of a frame assigned to the hub.

14. The method of claim 8 further comprises transmitting from the hub a synchronization signal with the conversation stream to the one or more participants.

15. The method of claim 8, wherein said wirelessly receiving comprises receiving the speech samples of each of the one or more participants in a burst over a time slot of a frame assigned to each of the one or more participants and buffering the burst of speech samples for combining the speech samples from each of the participants in the conversation into the conversation stream.

16. An apparatus used in wireless communication between participants in a conversation, comprising:
a microphone configured to receive speech of one participant in the conversation;
a sampling circuit configured to convert the speech into speech samples;
a processor configured to encode and modulate the speech samples, wherein the processor is further configured to demodulate and decode a conversation stream received from a hub, wherein the conversation stream includes the speech samples received by the hub from any and all of the participants in the conversation;
a transceiver configured to transmit the encoded and modulated speech samples to the hub and to receive the conversation stream from the hub in full duplex to stream the speech samples between any and all of the participants and the one participant; and
a headphone configured to radiate the conversation stream to the one participant to stream the speech from any and all of the participants in the conversation to the one participant.

17. The apparatus of claim 16, further comprising a synchronization circuitry to synchronize the full duplex communication with the hub.

18. An apparatus used in wireless communication between participants in a communication, comprising:
a transceiver configured to receive speech samples from headsets of any and all of the participants and to transmit a conversation stream in full duplex back to the headsets from which speech samples are received to stream the received speech samples between the headsets of any and all of the participants; and
a processor configured to demodulate and decode the speech samples from the headsets, to combine all the demodulated and decoded speech samples into combined samples, and to encode and to modulate the combined samples into the conversation stream.

19. The apparatus of claim 18, further comprising a synchronization circuitry to synchronize the full duplex communication with the one or more headsets.

20. The apparatus of claim 18, further comprising:
a microphone configured to receive speech samples from a local user; and
a headphone configured to radiate the conversation stream to the local user, wherein the processor is further configured to combine the speech samples from the local user with the demodulated and decoded speech samples from any and all of the headsets to generate the combined samples so that the conversation stream radiated to the local user and transmitted back to any and all of the headsets includes the speech samples from the local user and from any and all of the headsets.
